(19) United States
(12) Patent Application Publication
(10) Pub. No.: US 2017/0066225 A1
(43) Pub. Date: Mar. 9, 2017

(54) INTEGRATED FLEXIBLE TRANSPARENT CONDUCTIVE FILM

(71) Applicant: SABIC Global Technologies B.V., Bergen op Zoom (NL)

(72) Inventors: Zhe Chen, Shanghai (CN); Jing Chen, Shanghai (CN); Wei Feng, Shanghai (CN); Yuzhen Xu, Shanghai (CN)

(21) Appl. No.: 15/305,762

(22) PCT Filed: Apr. 20, 2015
(86) PCT No.: PCT/IB2015/052884

§ 371 Date: Oct. 21, 2016

Related U.S. Application Data
(60) Provisional application No. 61/982,579, filed on Apr. 22, 2014.

(51) Int. Cl. B32B 27/08; B32B 5/16; B29C 47/06; C08J 7/04; B32B 27/30; B32B 37/00; G06F 3/041; B32B 27/36; B29C 47/00

(52) U.S. Cl. CPC B32B 27/08; B32B 27/365; B32B 5/16; B29C 47/065; B29C 47/0021; B29C 47/0064; B29C 47/0004; B32B 27/308; B32B 37/025; G06F 3/041; C08J 7/047; B29K 2069/00

(57) ABSTRACT

An integrated conductive film can comprise: a first substrate including a first surface and a second surface, wherein the first substrate comprises a first polymer; a second substrate coupled to the second surface of the first substrate, wherein the second substrate comprises a second polymer, and wherein the chemical composition of the first polymer is different from the chemical composition of the second polymer; a transfer resin disposed adjacent to the first surface of the first substrate; a conductive coating disposed adjacent to the transfer resin, and wherein a change in electrical resistance of the integrated conductive film is less than or equal to 1 ohm when the film is bent to a bend radius of less than or equal to 126 millimeters as per ASTM D5023.

### BACKGROUND

An electronic device can have a control panel where a user can interact with the device. The control panel can have layers that can include a display source, a touch sensing device, and/or a cover window disposed over touch sensing device. The control panel can display information to a user and interpret the user's physical contact with a surface of the panel. A user can interact with the device by touching the surface of the cover window. An image can be projected through the panel from the display source. The user can interact with the device by touching the image on the surface of the cover window. The cover window can include glass which can provide a transparent protective layer and can cover the touch sensing device. Glass can be transparent and can be resilient to abrasion and thus can be suitable as a cover window. However, glass can be expensive, heavy, thick and inflexible and can be ill-suited for non-planar surface geometries.

Thus there is a need in the art for a transparent conductive film that can be inexpensive, thin, lightweight, abrasion resistant, and bent without damage, and can provide greater design freedom allowing for control panels with curved surfaces.

### BRIEF DESCRIPTION

An integrated conductive film can comprise: a first substrate including a first surface and a second surface, wherein the first substrate comprises a first polymer; a second substrate coupled to the second surface of the first substrate, wherein the second substrate comprises a second polymer, and wherein the chemical composition of the first polymer is different from the chemical composition of the second polymer; a transfer resin disposed adjacent to the first surface of the first substrate; a conductive coating disposed adjacent to the transfer resin, wherein the coating includes nanometer sized metal particles arranged in a network, and wherein the conductive coating has a surface resistance of less than or equal to 50 ohm/sq; and wherein the integrated conductive film has a transmittance of greater than or equal to 70% of incident light having a frequency of 430 THz to 790 THz, and wherein a change in electrical resistance of the integrated conductive film is less than or equal to 1 ohm when the film is bent to a bend radius of less than or equal to 126 millimeters as per ASTM D5023.

A method of forming an integrated conductive film can comprise: coextruding a substrate having a first surface and a second surface, wherein the first surface comprises a first polymer and the second surface comprises a second polymer, wherein the chemical composition of the first polymer is different from the chemical composition of the second polymer; applying a conductive coating to a transfer sheet, wherein the transfer sheet comprises a third polymer, wherein the coating includes nanometer sized metal particles arranged in a network, and wherein the conductive coating has a surface resistance of less than or equal to 50 ohm/sq; applying a transfer resin to the conductive coating or to the first surface of the substrate, wherein the transfer resin has a low adhesion to the transfer sheet; activating the transfer resin; pressing the transfer sheet and the substrate together, wherein the transfer resin is sandwiched between the conductive coating and the first surface of the substrate; curing the transfer resin; removing the transfer sheet to form the integrated conductive film wherein the integrated conductive film has a transmittance of greater than or equal to 70% of incident light having a frequency of 430 THz to 790 THz, and wherein a change in electrical resistance of the integrated conductive film is less than or equal to 1 ohm when the film is bent to a bend radius of less than or equal to 126 millimeters as per ASTM D5023.

An integrated conductive film can comprise: a polycarbonate substrate including a first surface and a second surface; a PMMA substrate coupled to the second surface of the polycarbonate substrate; a transfer resin disposed adjacent to the first surface of the polycarbonate substrate; a conductive coating disposed adjacent to the transfer resin, wherein the coating includes nanometer sized metal particles arranged in a network, and wherein the conductive coating has a surface resistance of less than or equal to 50 ohm/sq; and wherein the integrated conductive film has a transmittance of greater than or equal to 70% of incident light having a frequency of 430 THz to 790 THz, and wherein a change in electrical resistance of the integrated conductive film is less than or equal to 1 ohm when the film is bent to a bend radius of less than or equal to 126 millimeters as per ASTM D5023.

The above described and other features are exemplified by the following figures and detailed description.

### BRIEF DESCRIPTION OF THE DRAWINGS

Refer now to the figures, which are exemplary embodiments, and wherein the like elements are numbered alike.

FIG. 1 is an illustration of a bent integrated conductive film.

FIG. 2 is an illustration of a cross-sectional view of a bent integrated conductive film including a protective portion.

FIG. 3 is an illustration of a cross-sectional view of a portion of an integrated conductive film.

FIG. 4 is an illustration of a cross-sectional view of a portion of an integrated conductive film including a protective portion.

FIG. 5 is a schematic of the test setup used in the Example.

### DETAILED DESCRIPTION

A problem to be solved can include providing a flexible conductive film that can have good visible light transmittance, can have low surface resistance, and can be flexible enough for use in a variety of applications including touch screen applications. The present subject matter can help provide a solution to this problem, such as by providing a flexible, transparent, conductive film that is capable of being bent to a bend radius of less than or equal to 126 mm, for example, greater than or equal to 38 millimeters, without affecting the in-plane electrical resistance by more than 1 ohm.

Disclosed herein is an integrated conductive film. The integrated conductive film can include a substrate, a conductive coating, and a transfer resin. The integrated conductive film can be more flexible, lower cost, and lighter than glass panels while maintaining its touch sensing and abrasion resistant functionality.

The substrate can be any shape. The substrate can have a first surface and a second surface. The substrate can be a polymeric substrate. The first surface of the substrate can comprise a first polymer. The second surface of the substrate can comprise a second polymer. The first surface of the substrate can be disposed opposite the second surface of the substrate. The first surface of the substrate can consist of the first polymer. The second surface of the substrate can consist of the second polymer. The first surface of the substrate can consist of the first polymer and the second surface of the substrate can consist of the second polymer. The first polymer and the second polymer can be co-extruded to form the substrate. The first polymer and the second polymer can be different polymers, e.g. comprising different chemical compositions. The substrate can be flat and can include the first surface and the second surface opposite the first surface.

A transfer resin can be disposed adjacent to a surface of the substrate. For example, the transfer resin can be disposed adjacent to the first surface of the substrate. The transfer resin can abut a surface of the substrate. The transfer resin can include a polymer. The polymer of the transfer resin can include a thermosetting polymer. The polymer of the transfer resin can include a thermoplastic polymer. The thermosetting polymer can be activated by electromagnetic radiation (e.g., electromagnetic radiation in the ultraviolet (UV) spectrum having frequencies from 750 THz to 30 PHz), heat, drying, exposure to air, pressure (e.g. pressure sensitive adhesives) or a combination including at least one of the foregoing. The transfer resin can be used to transfer the conductive coating from a transfer sheet to the substrate. Upon curing, the adhesion strength of the transfer resin to the substrate and to the conductive coating layer can be greater than the adhesion strength to the transfer sheet, such that when the transfer resin is sandwiched between the substrate and the conductive coating layer and the transfer sheet is removed the transfer resin preferentially adheres to the substrate and the conductive coating rather than to the transfer sheet. For example the transfer resin can have an adhesion to the substrate and/or to the conductive coating of 5B and an adhesion to the transfer film of 0B as determined per ASTM D3359. The transfer resin can be in mechanical communication with both a surface of the conductive coating and a surface of the substrate.

The conductive coating can be disposed adjacent to a surface of the substrate. The conductive coating can abut the transfer resin. The conductive coating can be applied to a surface of a transfer sheet. The transfer resin can be applied to the conductive coating, which is applied to a transfer sheet. The transfer sheet including a conductive coating and a transfer resin can be coupled to a substrate such that the transfer resin abuts a surface of the substrate and is sandwiched between the conductive coating and the substrate, the transfer sheet can then be removed and the transfer resin and the conductive coating can be left adhered to the substrate. The transfer resin can at least partially surround the conductive coating. The conductive coating can be at least partially embedded in the transfer resin.

The transfer resin can be disposed on a surface of the substrate. The transfer sheet, including the conductive coating, can be coupled to the transfer resin disposed on the surface of the substrate, and the transfer sheet can be removed such that the conductive coating remains coupled to the transfer resin and adjacent to the substrate.

The integrated conductive film can optionally include a protective portion. The protective portion can provide abrasion resistance to the underlying integrated conductive film. The protective portion can be disposed adjacent to a surface of the substrate. The protective portion can abut a surface of the substrate. The protective portion can be disposed opposite the conductive coating. The protective portion can include a polymer.

FIG. 1 is an illustration of an integrated conductive film 2. The integrated conductive film 2 can include a first substrate 8, a second substrate 10, a transfer resin 6, and a conductive coating 4. The first substrate 8 can have a first surface 12 and a second surface 14. The conductive coating 4 can be disposed adjacent to the first surface 12 of the first substrate 8. The transfer resin 6 can be applied directly to the first surface 12 of the first substrate 8 or the transfer resin 6 can be applied to a conductive coating 4 adhered to a transfer sheet. The transfer sheet can then be coupled to the first surface 12 of the first substrate 8, such that the transfer resin 6 is sandwiched between the conductive coating 4 and the first surface 12 of the first substrate 8, then the transfer sheet can be removed, leaving the transfer resin 6 and the conductive coating 4 adjacent to the first surface 12 of the first substrate 8. The integrated conductive film 2 can be curved in at least one dimension, e.g. the w-axis dimension. The integrated conductive film 2 can be curved in at least two dimensions, e.g. the w-axis and h-axis dimensions. The integrated conductive film 2 can have a width, W, measured along a w-axis. The integrated conductive film 2 can have a depth, D, measured along a d-axis. The integrated conductive film 2 can have a length, H, measured along the h-axis. The depth, D, can be larger than the total thickness, T, of the integrated conductive film 2. The integrated conductive film 2 can be flexible such that the change in the electrical resistance (measured between point A to point B) can be less than or equal to 1 ohm when the integrated conductive film 2 is bent to a bend radius 30 of 38 millimeters (mm) to 126 mm measured from a center axis 16. The thickness, T, of the integrated conductive film 2 can be 0.01 mm to 10 mm, for example, 0.01 mm to 5 mm, or, 0.05 mm to 3 mm. The integrated conductive film 2 can be curved. The depth, D, can be larger than twice the total thickness, T, of the integrated conductive film 2. The integrated conductive film 2 can have a maximum depth anywhere along the film.

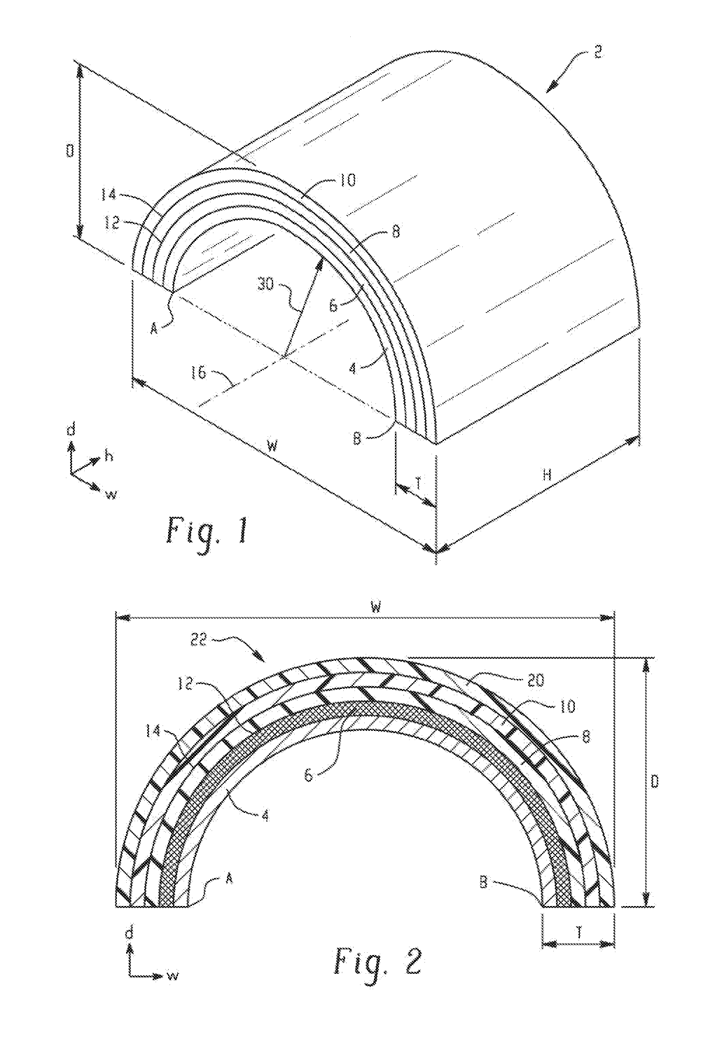

FIG. 2 is an illustration of a cross-section of an integrated conductive film 22. The integrated conductive film 22 can include a first substrate 8, a second substrate 10, a transfer resin 6, and a conductive coating 4. The integrated conductive film 22 can optionally include a protective portion 20. The protective portion 20 can be disposed adjacent to a surface of the second substrate 10. The protective portion 20 can be coupled to a surface of the second substrate 10. The protective portion 20 can abut a surface of the second substrate 10 and can be disposed opposite the first substrate 8. The protective portion 20 can provide an underlying layer with resistance to abrasion. The protective portion can include silicone based or acrylic based hard coat, which can be applied to a surface of the substrate to enhance the abrasion resistance of the substrate.

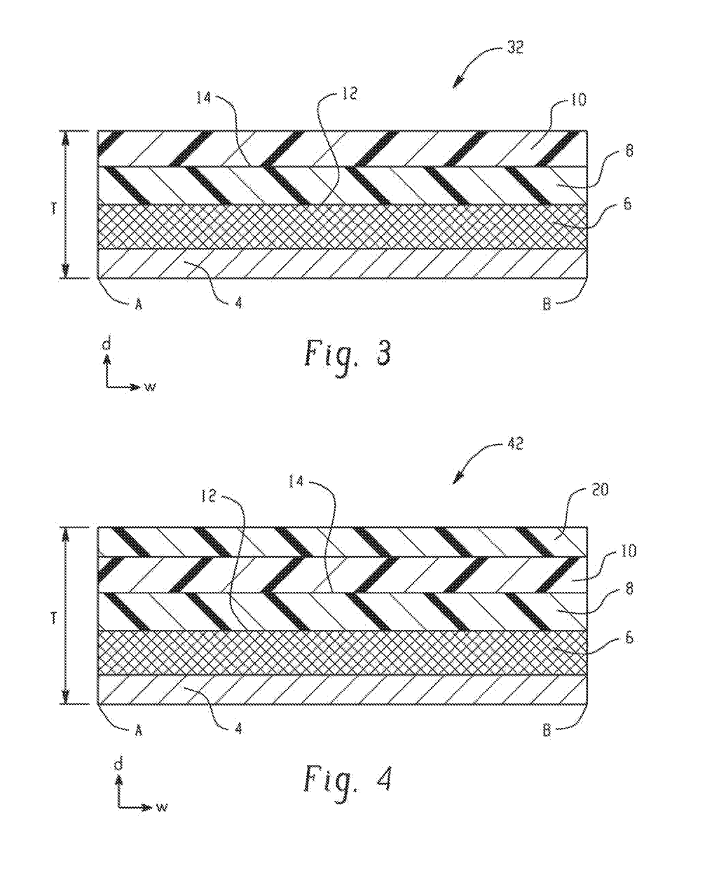

FIG. 3 is an illustration of a cross-section of a portion of an integrated conductive film 32. The integrated conductive film 32 can include a first substrate 8, a second substrate 10, a transfer resin 6, and a conductive coating 4. The transfer resin 6 can be disposed between the first surface 12 of the first substrate 8 and the conductive coating 4. The electrical resistance through the integrated conductive film 32 can be measured from point A to point B.

FIG. 4 is an illustration of a cross-section of a portion of an integrated conductive film 42. The integrated conductive film 42 can include a first substrate 8, a second substrate 10, a transfer resin 6, a conductive coating 4, and an optional protective portion 20. The optional protective portion 20 can be disposed adjacent to a surface of the second substrate 10 opposite the surface facing the first substrate 8. The electrical resistance through the integrated conductive film 42 can be measured from point A to point B. The protective portion 20 can be a wet coating. The protective portion 20 can be applied using any suitable wet coating technique, e.g., roller coating, screen printing, spreading, spray coating, spin coating, dipping, and the like. The protective portion 20 can be a film, or can be applied to a film, which can be adhered to a surface of the second substrate 10. An adhesion promoter can be incorporated into a film having a protective portion 20 to improve adherence to a side of the integrated conductive film 42.

The integrated conductive film can be flexible and conductive. The change in the electrical resistance from one edge to another edge (e.g. the in-plane electrical resistance) of the integrated conductive film (e.g., point A to point B illustrated in the figures) can be less than or equal to 1 ohm while the film is being bent to a bend radius less than or equal to 126 mm, for example, 38 mm to 126 mm, for example, 38 mm to 67 mm, or, 38 mm to 48 mm, or, 38 mm to 41 mm, or, 38 mm as determined per ASTM D5023. The electrical resistance of the integrated conductive film can be measured through the film along a path that is parallel to the surface of the film at any point along the path from one edge to another edge of the film (e.g., through the conductive coating from point A to point B in the attached figures).

The integrated conductive film can have an adhesion sufficient to pass the peel testing defined by ASTM D3359. For example, the conductive coating can be adhered to a substrate and can exhibit an adhesion strength of 5B as determined per ASTM D3359.

The substrate can be formed by any polymer forming process. For example, a substrate can be formed by a co-extrusion process. The substrate can be co-extruded into a flat sheet. The substrate can be co-extruded into a flat sheet including a first surface comprising a first polymer and a second surface comprising a second polymer having a different chemical composition than the first polymer. The substrate can be co-extruded into a flat sheet including a first surface consisting of only a first polymer and a second surface consisting of only a second polymer having a different chemical composition than the first polymer. The substrate can be co-extruded into a flat sheet including a first surface consisting of polycarbonate and a second surface consisting of poly(methyl methacrylate) (PMMA).

The conductive coating can be disposed on the surface of a transfer sheet. The conductive coating can be applied to a surface of the transfer sheet using any suitable wet coating technique, e.g., screen printing, spreading, meyer bar coating, gravure coating, spray coating, spin coating, dipping, and the like. The conductive coating can be coupled to a surface of the transfer sheet.

A transfer resin can be applied to the conductive coating coupled to a surface of the transfer sheet. The transfer resin can be applied to a surface of the substrate. The transfer resin can be applied to a surface of the substrate comprising polycarbonate. The transfer resin can be activated, e.g., with ultraviolet (UV) light and/or heat. The transfer sheet can be coupled to a surface of the substrate such that the transfer resin is disposed between the conductive coating and a surface of the substrate. The transfer resin can be disposed between the conductive coating and a surface of the substrate comprising polycarbonate. The transfer resin can be disposed between the conductive coating and a surface of the substrate consisting of polycarbonate.

The transfer resin can be cured. Curing the transfer resin can include waiting, heating, drying, exposing to electromagnetic radiation (e.g., electromagnetic radiation (EMR) in the UV spectrum), or a combination of one of the foregoing. The transfer sheet can be removed, leaving the transfer resin and conductive coating adhered to a surface of the film.

The transfer sheet can include a polymer. The adhesion between the conductive coating and the polymer of the transfer sheet can be low compared to the adhesion between the conductive coating and the transfer resin. The adhesion between conductive coating and the transfer sheet can be 0B as determined per ASTM D3359. The adhesion between conductive coating and the transfer resin can be 5B as determined per ASTM D3359. The adhesion between transfer resin and the transfer sheet can be 0B as determined per ASTM D3359.

The transfer sheet can be applied to a surface of the substrate by any application process that will provide the desired properties. The process can include pressuring the transfer sheet and the substrate together, activating the transfer resin, such as with UV light or heat. For example the transfer sheet can be applied to the substrate by a roll to sheet transfer, stamping, roller pressing, belt pressing including double belt pressing, or a combination comprising at least one of the foregoing. Pressuring the transfer sheet and the substrate together can include pressing to a pressure greater than 0.2 megaPascal (MPa), for example 0.2 MPa to 1 MPa, or, 0.2 MPa to 0.5 MPa, or, 0.3 MPa.

A substrate can include a first surface consisting of polycarbonate and a second surface opposite the first surface consisting of PMMA. The conductive coating can be applied to a surface of a polyethylene terephthalate (PET) transfer sheet. A UV activated transfer resin can be applied to the conductive coating or to the polycarbonate surface of the substrate. The substrate and the transfer film can be heated to 95° C. for about 20 minutes. Once heated, the conductive coating side of the transfer film can be applied to the polycarbonate surface of the substrate and the stack introduced to a laminator. The laminator can press the stack and remove air bubbles trapped between the layers. The stack can then be exposed to UV light in a UV curing oven until the transfer resin has cured. The transfer sheet can then be removed.

A protective portion can be applied to a surface of the substrate to provide variable gloss and printability and/or to enhance the chemical resistivity, hardness, and/or abrasion resistance of the substrate. A protective portion can include a silicone based and/or acrylic based hard coating, film, or coated film. A protective portion can be adhered to a surface of the substrate comprising PMMA. The thickness of the protective portion can be from 1 micrometer (μm) to 100 μm, for example, 1 μm to 75 μm, or, 5 μm to 50 μm.

The integrated conductive film can be bent such that it is not flat. The substrate can be bent such that it is not coplanar with a plane defined by the height and width dimensions of the substrate. The substrate can be bent into a curved shape such that a depth dimension exceeds a maximum thickness of the substrate (e.g., acknowledging that the thickness of the substrate can vary due to imperfections in manufacturing, such as tool tolerances, variations in process conditions such as temperature, variation in shrinkage during cooling, and the like). The substrate can be bent such that a portion of the substrate has a depth dimension greater than or equal to twice the average thickness of the panel.

The perimeter shape of the integrated conductive film can be any shape, e.g. circular, elliptical, or the shape of a polygon having straight or curved edges.

The conductive coating can contain an EMR shielding material. The conductive coating can include pure metals such as silver (Ag), nickel (Ni), copper (Cu), or similar shielding metal, metal oxides thereof, combinations comprising at least one of the foregoing, or metal alloys comprising at least one of the foregoing, or metals or metal alloys produced by the Metallurgic Chemical Process (MCP) described in U.S. Pat. No. 5,476,535. Metals of the conductive coating can be nanometer sized, e.g., such as where 90% of the particles can have an equivalent spherical diameter of less than 100 nanometers (nm). The metals of the conductive coating can form a network of interconnected metal traces defining openings on the substrate surface to which it is applied. The surface resistance of the conductive coating can be less than or equal to 50 ohms per square (ohm/sq), for example, less than or equal to 25 ohm/sq, or, less than or equal to 10 ohm/sq.

A polymer of the integrated conductive film, or used in the manufacture of the integrated conductive film (e.g., transfer sheet), can include a thermoplastic resin, a thermoset resin, or a combination comprising at least one of the foregoing.

Possible thermoplastic resins include, but are not limited to, oligomers, polymers, ionomers, dendrimers, copolymers such as graft copolymers, block copolymers (e.g., star block copolymers, random copolymers, and the like) or a combination comprising at least one of the foregoing. Examples of such thermoplastic resins include, but are not limited to, polycarbonates (e.g., blends of polycarbonate (such as, polycarbonate-polybutadiene blends, copolyester polycarbonates)), polystyrenes (e.g., copolymers of polycarbonate and styrene, polyphenylene ether-polystyrene blends), polyimides (PI) (e.g., polyetherimides (PEI)), acrylonitrile-styrene-butadiene (ABS), polyalkylmethacrylates (e.g., polymethylmethacrylates (PMMA)), polyesters (e.g., copolyesters, polythioesters), polyolefins (e.g., polypropylenes (PP) and polyethylenes, high density polyethylenes (HDPE), low density polyethylenes (LDPE), linear low density polyethylenes (LLDPE)), polyamides (e.g., polyamideimides), polyarylates, polysulfones (e.g., polyarylsulfones, polysulfonamides), polyphenylene sulfides, polytetrafluoroethylenes, polyethers (e.g., polyether ketones (PEK), polyether etherketones (PEEK), polyethersulfones (PES)), polyacrylics, polyacetals, polybenzoxazoles (e.g., polybenzothiazinophenothiazines, polybenzothiazoles), polyoxadiazoles, polypyrazinoquinoxalines, polypyromellitimides, polyquinoxalines, polybenzimidazoles, polyoxindoles, polyoxoisoindolines (e.g., polydioxoisoindolines), polytriazines, polypyridazines, polypiperazines, polypyridines, polypiperidines, polytriazoles, polypyrazoles, polypyrrolidones, polycarboranes, polyoxabicyclononanes, polydibenzofurans, polyphthalamide, polyacetals, polyanhydrides, polyvinyls (e.g., polyvinyl ethers, polyvinyl thioethers, polyvinyl alcohols, polyvinyl ketones, polyvinyl halides, polyvinyl nitriles, polyvinyl esters, polyvinylchlorides), polysulfonates, polysulfides, polyureas, polyphosphazenes, polysilazanes, polysiloxanes, fluoropolymers (e.g., polyvinyl fluourides (PVF), polyvinylidene fluorides (PVDF), fluorinated ethylene-propylenes (FEP), polyethylene tetrafluoroethylenes (ETFE)), polyethylene naphthalates (PEN), cyclic olefin copolymers (COC), or a combination comprising at least one of the foregoing.

More particularly, a thermoplastic resin can include, but is not limited to, polycarbonate resins (e.g., LEXAN™ resins, including LEXAN™ CFR resins, commercially available from SABIC's Innovative Plastics business), polyphenylene ether-polystyrene resins (e.g., NORYL™ resins, commercially available from SABIC's Innovative Plastics business), polyetherimide resins (e.g., ULTEM™ resins, commercially available from SABIC's Innovative Plastics business), polybutylene terephthalate-polycarbonate resins (e.g., XENOY™ resins, commercially available from SABIC's Innovative Plastics business), copolyestercarbonate resins (e.g., LEXAN™ SLX resins, commercially available from SABIC's Innovative Plastics business), or a combination comprising at least one of the foregoing resins. Even more particularly, the thermoplastic resins can include, but are not limited to, homopolymers and copolymers of a polycarbonate, a polyester, a polyacrylate, a polyamide, a polyetherimide, a polyphenylene ether, or a combination comprising at least one of the foregoing resins. The polycarbonate can comprise copolymers of polycarbonate (e.g., polycarbonate-polysiloxane, such as polycarbonate-polysiloxane block copolymer, polycarbonate-dimethyl bisphenol cyclohexane (DMBPC) polycarbonate copolymer (e.g., LEXAN™ DMX and LEXAN™ XHT resins commercially available from SABIC's Innovative Plastics business), polycarbonate-polyester copolymer (e.g., XYLEX™ resins, commercially available from SABIC's Innovative Plastics business),), linear polycarbonate, branched polycarbonate, end-capped polycarbonate (e.g., nitrile end-capped polycarbonate), or a combination comprising at least one of the foregoing, for example, a combination of branched and linear polycarbonate.

As used herein, the term “polycarbonate” means compositions having repeating structural carbonate units of formula (1)

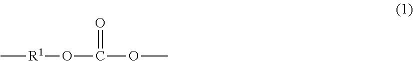

in which at least 60 percent of the total number of R¹ groups contain aromatic moieties and the balance thereof are aliphatic, alicyclic, or aromatic. In an embodiment, each R¹ is a C₆₋₃₀ aromatic group, that is, contains at least one aromatic moiety. R¹ can be derived from a dihydroxy compound of the formula HO—R¹—OH, in particular of formula (2)

HO-A¹-Y¹-A²-OH (2)

wherein each of A¹ and A² is a monocyclic divalent aromatic group and Y¹ is a single bond or a bridging group having one or more atoms that separate A¹ from A². In an exemplary embodiment, one atom separates A¹ from A². Specifically, each R¹ can be derived from a dihydroxy aromatic compound of formula (3)

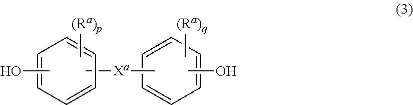

wherein R^{a} and R^{b} each represent a halogen or C₁₋₁₂ alkyl group and can be the same or different; and p and q are each independently integers of 0 to 4. It will be understood that R^{a} is hydrogen when p is 0, and likewise R^{b} is hydrogen when q is 0. Also in formula (3), X^{a} represents a bridging group connecting the two hydroxy-substituted aromatic groups, where the bridging group and the hydroxy substituent of each C₆ arylene group are disposed ortho, meta, or para (specifically para) to each other on the C₆ arylene group. In an embodiment, the bridging group X^{a} is single bond, —O—, —S—, —S(O)—, —S(O)₂—, —C(O)—, or a C₁₋₁₈ organic group. The C₁₋₁₈ organic bridging group can be cyclic or acyclic, aromatic or non-aromatic, and can further comprise heteroatoms such as halogens, oxygen, nitrogen, sulfur, silicon, or phosphorous. The C₁₋₁₈ organic group can be disposed such that the C₆ arylene groups connected thereto are each connected to a common alkylidene carbon or to different carbons of the C₁₋₁₈ organic bridging group. In one embodiment, p and q are each 1, and R^{a} and R^{b} are each a C₁₋₃ alkyl group, specifically methyl, disposed meta to the hydroxy group on each arylene group.

In an embodiment, X^{a} is a substituted or unsubstituted C₃₋₁₈ cycloalkylidene, a C₁₋₂₅ alkylidene of formula —C(R^{c})(R^{d})— wherein R^{e} and R^{d} are each independently hydrogen, C₁₋₁₂ alkyl, C₁₋₁₂ cycloalkyl, C₇₋₁₂ arylalkyl, C₁₋₁₂ heteroalkyl, or cyclic C₇₋₁₂ heteroarylalkyl, or a group of the formula —C(═R^{e})— wherein R^{e} is a divalent C₁₋₁₂ hydrocarbon group. Exemplary groups of this type include methylene, cyclohexylmethylene, ethylidene, neopentylidene, and isopropylidene, as well as 2-[2.2.1]-bicycloheptylidene, cyclohexylidene, cyclopentylidene, cyclododecylidene, and adamantylidene. A specific example wherein X^{a} is a substituted cycloalkylidene is the cyclohexylidene-bridged, alkyl-substituted bisphenol of formula (4)

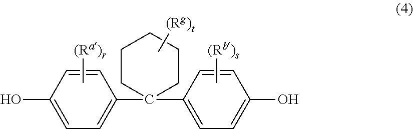

wherein R^{a′} and R^{b′} are each independently C₁₋₁₂ alkyl, R^{g} is C₁₋₁₂ alkyl or halogen, r and s are each independently 1 to 4, and t is 0 to 10. In a specific embodiment, at least one of each of R^{a′} and R^{b′} are disposed meta to the cyclohexylidene bridging group. The substituents R^{a′}, R^{a′}, and R^{b′} can, when comprising an appropriate number of carbon atoms, be straight chain, cyclic, bicyclic, branched, saturated, or unsaturated. In an embodiment, R^{a′} and R^{b′} are each independently C₁₋₄ alkyl, R^{g} is C₁₋₄ alkyl, r and s are each 1, and t is 0 to 5. In another specific embodiment, R^{a′}, R^{b′} and R^{g} are each methyl, r and s are each 1, and t is 0 or 3. The cyclohexylidene-bridged bisphenol can be the reaction product of two moles of o-cresol with one mole of cyclohexanone. In another exemplary embodiment, the cyclohexylidene-bridged bisphenol is the reaction product of two moles of a cresol with one mole of a hydrogenated isophorone (e.g., 1,1,3-trimethyl-3-cyclohexane-5-one). Such cyclohexane-containing bisphenols, for example the reaction product of two moles of a phenol with one mole of a hydrogenated isophorone, are useful for making polycarbonate polymers with high glass transition temperatures and high heat distortion temperatures.

In another embodiment, X^{a} is a C₁₋₁₈ alkylene group, a C₃₋₁₈ cycloalkylene group, a fused C₆₋₁₈ cycloalkylene group, or a group of the formula —B¹—W—B²— wherein B¹ and B² are the same or different C₁₋₆ alkylene group and W is a C₃₋₁₂ cycloalkylidene group or a C₆₋₁₆ arylene group.

X^{a} can also be a substituted C₃₋₁₈ cycloalkylidene of formula (5)

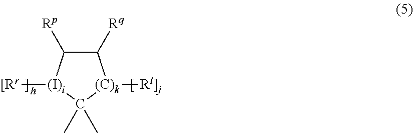

wherein R^{r}, R^{p}, R^{q}, and R^{t} are independently hydrogen, halogen, oxygen, or C₁₋₁₂ organic groups; I is a direct bond, a carbon, or a divalent oxygen, sulfur, or —N(Z)— where Z is hydrogen, halogen, hydroxy, C₁₋₁₂ alkyl, C₁₋₁₂ alkoxy, or C₁₋₁₂ acyl; h is 0 to 2, j is 1 or 2, i is an integer of 0 or 1, and k is an integer of 0 to 3, with the proviso that at least two of R^{r}, R^{p}, R^{q}, and R^{t} taken together are a fused cycloaliphatic, aromatic, or heteroaromatic ring. It will be understood that where the fused ring is aromatic, the ring as shown in formula (5) will have an unsaturated carbon-carbon linkage where the ring is fused. When k is 1 and i is 0, the ring as shown in formula (5) contains 4 carbon atoms, when k is 2, the ring as shown in formula (5) contains 5 carbon atoms, and when k is 3, the ring contains 6 carbon atoms. In one embodiment, two adjacent groups (e.g., R^{q} and R^{t} taken together) form an aromatic group, and in another embodiment, R^{q} and R^{t} taken together form one aromatic group and R⁴ and R^{p} taken together form a second aromatic group. When R^{q} and R^{t} taken together form an aromatic group, R^{p} can be a double-bonded oxygen atom, i.e., a ketone.

Other useful aromatic dihydroxy compounds of the formula HO—R¹—OH include compounds of formula (6)

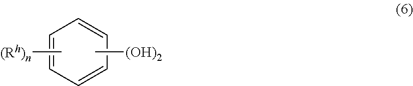

wherein each R^{h} is independently a halogen atom, a C₁₋₁₀ hydrocarbyl such as a C₁₋₁₀ alkyl group, a halogen-substituted C₁₋₁₀ alkyl group, a C₆₋₁₀ aryl group, or a halogen-substituted C₆₋₁₀ aryl group, and n is 0 to 4. The halogen is usually bromine.

Some illustrative examples of specific aromatic dihydroxy compounds include the following: 4,4′-dihydroxybiphenyl, 1,6-dihydroxynaphthalene, 2,6-dihydroxynaphthalene, bis(4-hydroxyphenyl)methane, bis(4-hydroxyphenyl)diphenylmethane, bis(4-hydroxyphenyl)-1-naphthylmethane, 1,2-bis(4-hydroxyphenyl)ethane, 1,1-bis(4-hydroxyphenyl)-1-phenylethane, 2-(4-hydroxyphenyl)-2-(3-hydroxyphenyl)propane, bis(4-hydroxyphenyl)phenylmethane, 2,2-bis(4-hydroxy-3-bromophenyl)propane, 1,1-bis(hydroxyphenyl)cyclopentane, 1,1-bis(4-hydroxyphenyl)cyclohexane, 1,1-bis(4-hydroxyphenyl)isobutene, 1,1-bis(4-hydroxyphenyl)cyclododecane, trans-2,3-bis(4-hydroxyphenyl)-2-butene, 2,2-bis(4-hydroxyphenyl)adamantane, alpha, alpha′-bis(4-hydroxyphenyl)toluene, bis(4-hydroxyphenyl)acetonitrile, 2,2-bis(3-methyl-4-hydroxyphenyl)propane, 2,2-bis(3-ethyl-4-hydroxyphenyl)propane, 2,2-bis(3-n-propyl-4-hydroxyphenyl)propane, 2,2-bis(3-isopropyl-4-hydroxyphenyl)propane, 2,2-bis(3-sec-butyl-4-hydroxyphenyl)propane, 2,2-bis(3-t-butyl-4-hydroxyphenyl)propane, 2,2-bis(3-cyclohexyl-4-hydroxyphenyl)propane, 2,2-bis(3-allyl-4-hydroxyphenyl)propane, 2,2-bis(3-methoxy-4-hydroxyphenyl)propane, 2,2-bis(4-hydroxyphenyl)hexafluoropropane, 1,1-dichloro-2,2-bis(4-hydroxyphenyl)ethylene, 1,1-dibromo-2,2-bis(4-hydroxyphenyl)ethylene, 1,1-dichloro-2,2-bis(5-phenoxy-4-hydroxyphenyl)ethylene, 4,4′-dihydroxybenzophenone, 3,3-bis(4-hydroxyphenyl)-2-butanone, 1,6-bis(4-hydroxyphenyl)-1,6-hexanedione, ethylene glycol bis(4-hydroxyphenyl)ether, bis(4-hydroxyphenyl)ether, bis(4-hydroxyphenyl)sulfide, bis(4-hydroxyphenyl)sulfoxide, bis(4-hydroxyphenyl)sulfone, 9,9-bis(4-hydroxyphenyl)fluorine, 2,7-dihydroxypyrene, 6,6′-dihydroxy-3,3,3′,3′-tetramethylspiro(bis)indane (“spirobiindane bisphenol”), 3,3-bis(4-hydroxyphenyl)phthalimide, 2,6-dihydroxydibenzo-p-dioxin, 2,6-dihydroxythianthrene, 2,7-dihydroxyphenoxathin, 2,7-dihydroxy-9,10-dimethylphenazine, 3,6-dihydroxydibenzofuran, 3,6-dihydroxydibenzothiophene, and 2,7-dihydroxycarbazole, resorcinol, substituted resorcinol compounds such as 5-methyl resorcinol, 5-ethyl resorcinol, 5-propyl resorcinol, 5-butyl resorcinol, 5-t-butyl resorcinol, 5-phenyl resorcinol, 5-cumyl resorcinol, 2,4,5,6-tetrafluoro resorcinol, 2,4,5,6-tetrabromo resorcinol, or the like; catechol; hydroquinone; substituted hydroquinones such as 2-methyl hydroquinone, 2-ethyl hydroquinone, 2-propyl hydroquinone, 2-butyl hydroquinone, 2-t-butyl hydroquinone, 2-phenyl hydroquinone, 2-cumyl hydroquinone, 2,3,5,6-tetramethyl hydroquinone, 2,3,5,6-tetra-t-butyl hydroquinone, 2,3,5,6-tetrafluoro hydroquinone, 2,3,5,6-tetrabromo hydroquinone, or the like, or combinations comprising at least one of the foregoing dihydroxy compounds.

Specific examples of bisphenol compounds of formula (3) include 1,1-bis(4-hydroxyphenyl) methane, 1,1-bis(4-hydroxyphenyl) ethane, 2,2-bis(4-hydroxyphenyl) propane (hereinafter “bisphenol A” or “BPA”), 2,2-bis(4-hydroxyphenyl) butane, 2,2-bis(4-hydroxyphenyl) octane, 1,1-bis(4-hydroxyphenyl) propane, 1,1-bis(4-hydroxyphenyl) n-butane, 2,2-bis(4-hydroxy-2-methylphenyl) propane, 1,1-bis(4-hydroxy-t-butylphenyl) propane, 3,3-bis(4-hydroxyphenyl) phthalimidine, 2-phenyl-3,3-bis(4-hydroxyphenyl) phthalimidine (p,p-PPPBP), and 1,1-bis(4-hydroxy-3-methylphenyl)cyclohexane (DMBPC). Combinations comprising at least one of the foregoing dihydroxy compounds can also be used. In one specific embodiment, the polycarbonate is a linear homopolymer derived from bisphenol A, in which each of A¹ and A² is p-phenylene and Y¹ is isopropylidene in formula (3).

The homopolymer of DMBPC carbonate, which is represented by the x portion of formula (7) or its copolymer with BPA carbonate has an overall chemical structure represented by formula (7)

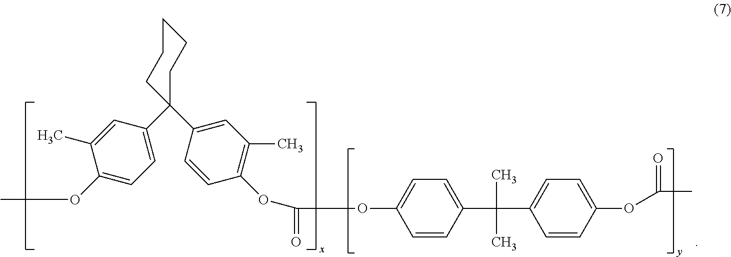

DMBPC carbonate can be co-polymerized with BPA carbonate to form a DMBPC BPA co-polycarbonate. For example, DMBPC based polycarbonate as a copolymer or homopolymer (DMBPC) can comprise 10 to 100 mol % DMBPC carbonate and 90 to 0 mol % BPA carbonate.

The method of making any of the polycarbonates herein described is not particularly limited. It may be produced by any known method of producing polycarbonate including the interfacial process using phosgene and/or the melt process using a diaryl carbonate, such as diphenyl carbonate or bismethyl salicyl carbonate, as the carbonate source.

“Polycarbonates” as used herein further include homopolycarbonates, (wherein each R¹ in the polymer is the same), copolymers comprising different R¹ moieties in the carbonate (referred to herein as “copolycarbonates”), copolymers comprising carbonate units and other types of polymer units, such as ester units, and combinations comprising at least one of homopolycarbonates and/or copolycarbonates. As used herein, a “combination” is inclusive of blends, mixtures, alloys, reaction products, and the like.

The polycarbonate composition can further include impact modifier(s). Exemplary impact modifiers include natural rubber, fluoroelastomers, ethylene-propylene rubber (EPR), ethylene-butene rubber, ethylene-propylene-diene monomer rubber (EPDM), acrylate rubbers, hydrogenated nitrile rubber (HNBR) silicone elastomers, and elastomer-modified graft copolymers such as styrene-butadiene-styrene (SBS), styrene-butadiene rubber (SBR), styrene-ethylene-butadiene-styrene (SEBS), acrylonitrile-butadiene-styrene (ABS), acrylonitrile-ethylene-propylene-diene-styrene (AES), styrene-isoprene-styrene (SIS), methyl methacrylate-butadiene-styrene (MBS), high rubber graft (HRG), and the like. Impact modifiers are generally present in amounts of 1 to 30 wt. %, based on the total weight of the polymers in the composition.

A polymer of the integrated conductive film can include various additives ordinarily incorporated into polymer compositions of this type, with the proviso that the additive(s) are selected so as to not significantly adversely affect the desired properties of the polymeric composition, in particular hydrothermal resistance, water vapor transmission resistance, puncture resistance, and thermal shrinkage. Such additives can be mixed at a suitable time during the mixing of the components for forming the composition. Exemplary additives include fillers, reinforcing agents, antioxidants, heat stabilizers, light stabilizers, ultraviolet (UV) light stabilizers, plasticizers, lubricants, mold release agents, antistatic agents, colorants such as titanium dioxide, carbon black, and organic dyes, surface effect additives, radiation stabilizers, flame retardants, and anti-drip agents. A combination of additives can be used, for example a combination of a heat stabilizer, mold release agent, and ultraviolet light stabilizer. The total amount of additives (other than any impact modifier, filler, or reinforcing agents) is generally 0.01 to 5 wt. %, based on the total weight of the composition.

Light stabilizers and/or ultraviolet light (UV) absorbing stabilizers can also be used. Exemplary light stabilizer additives include benzotriazoles such as 2-(2-hydroxy-5-methylphenyl)benzotriazole, 2-(2-hydroxy-5-tert-octylphenyl)-benzotriazole and 2-hydroxy-4-n-octoxy benzophenone, or combinations comprising at least one of the foregoing light stabilizers. Light stabilizers are used in amounts of 0.01 to 5 parts by weight, based on 100 parts by weight of the total composition, excluding any filler.

UV light absorbing stabilizers include triazines, dibenzoylresorcinols (such as TINUVIN* 1577 commercially available from BASF and ADK STAB LA-46 commercially available from Asahi Denka), hydroxybenzophenones; hydroxybenzotriazoles; hydroxyphenyl triazines (e.g., 2-hydroxyphenyl triazine); hydroxybenzotriazines; cyanoacrylates; oxanilides; benzoxazinones; 2-(2H-benzotriazol-2-yl)-4-(1,1,3,3-tetramethylbutyl)-phenol (CYASORB* 5411); 2-hydroxy-4-n-octyloxybenzophenone (CYASORB* 531); 2-[4,6-bis(2,4-dimethylphenyl)-1,3,5-triazin-2-yl]-5-(octyloxy)-phenol (CYASORB* 1164); 2,2′-(1,4-phenylene)bis(4H-3,1-benzoxazin-4-one) (CYASORB* UV-3638); 1,3-bis[(2-cyano-3,3-diphenylacryloyl)oxy]-2,2-bis[[(2-cyano-3,3-diphenylacryloyl)oxy]methyl]propane (UVINUL* 3030); 2,2′-(1,4-phenylene) bis(4H-3,1-benzoxazin-4-one); 1,3-bis[(2-cyano-3,3-diphenylacryloyl)oxy]-2,2-bis[[(2-cyano-3,3-diphenylacryloyl)oxy]methyl]propane; nano-size inorganic materials such as titanium oxide, cerium oxide, and zinc oxide, all with a particle size less than or equal to 100 nanometers, or combinations comprising at least one of the foregoing UV light absorbing stabilizers. UV light absorbing stabilizers are used in amounts of 0.01 to 5 parts by weight, based on 100 parts by weight of the total composition, excluding any filler.

The transfer resin can include a multifunctional acrylate oligomer and an acrylate monomer. The transfer resin can include a photoinitiator. The multifunctional acrylate oligomer can include an aliphatic urethane acrylate oligomer, a pentaerythritol tetraacrylate, an aliphatic urethane acrylate, an acrylic ester, a dipentaerythritol dexaacrylate, an acrylated resin, a trimethylolpropane triacrylate (TMPTA), a dipentaerythritol pentaacrylate ester, or a combination comprising at least one of the foregoing. In an embodiment, the multifunctional acrylate can include DOUBLEMER™ 5272 (DM5272) (commercially available from Double Bond Chemical Ind., Co., LTD., of Taipei, Taiwan, R.O.C.) which includes an aliphatic urethane acrylate oligomer in an amount from 30 weight percent (wt. %) to 50 wt. % of the multifunctional acrylate and a pentaerythritol tetraacrylate in an amount from 50 wt. % to 70 wt. % of the multifunctional acrylate.

The transfer resin can optionally include a polymerization initiator to promote polymerization of the acrylate components. The optional polymerization initiators can include photoinitiators that promote polymerization of the components upon exposure to ultraviolet radiation.

The transfer resin can include the multifunctional acrylate oligomer in an amount of 30 wt. % to 90 wt. % for example, 30 wt. % to 85 wt. %, or, 30 wt. % to 80 wt. %; the acrylate monomers in an amount of 5 wt. % to 65 wt. %, for example, 8 wt. % to 65 wt. %, or, 15 wt. % to 65 wt. %; and the optional polymerization initiator present in an amount of 0 wt. % to 10 wt. %, for example, 2 wt. % to 8 wt. %, or, 3 wt. % to 7 wt. %, wherein weight is based on the total weight of the transfer resin.

An aliphatic urethane acrylate oligomer can include 2 to 15 acrylate functional groups, for example, 2 to 10 acrylate functional groups.

The acrylate monomer (e.g., 1,6-hexanediol diacrylate, meth(acrylate) monomer) can include 1 to 5 acrylate functional groups, for example, 1 to 3 acrylate functional group(s). In an embodiment, the acrylate monomer can be 1,6-hexanediol diacrylate (HDDA).

The multifunctional acrylate oligomer can include a compound produced by reacting an aliphatic isocyanate with an oligomeric diol such as a polyester diol or polyether diol to produce an isocyanate capped oligomer. This oligomer can then be reacted with hydroxy ethyl acrylate to produce the urethane acrylate.

The multifunctional acrylate oligomer can be an aliphatic urethane acrylate oligomer, for example, a wholly aliphatic urethane (meth)acrylate oligomer based on an aliphatic polyol, which is reacted with an aliphatic polyisocyanate and acrylated. In one embodiment, the multifunctional acrylate oligomer can be based on a polyol ether backbone. For example, an aliphatic urethane acrylate oligomer can be the reaction product of (i) an aliphatic polyol; (ii) an aliphatic polyisocyanate; and (iii) an end capping monomer capable of supplying reactive terminus. The polyol (i) can be an aliphatic polyol, which does not adversely affect the properties of the composition when cured. Examples include polyether polyols; hydrocarbon polyols; polycarbonate polyols; polyisocyanate polyols, and mixtures thereof.

The multifunctional acrylate oligomer can include an aliphatic urethane tetraacrylate (i.e., a maximum functionality of 4) that can be diluted 20% by weight with a acrylate monomer, e.g., 1,6-hexanediol diacrylate (HDDA), tripropyleneglycol diacrylate (TPGDA), and trimethylolpropane triacrylate (TMPTA). A commercially available urethane acrylate that can be used in forming the transfer resin can be EBECRYL™ 8405, EBECRYL™ 8311, or EBECRYL™ 8402, each of which is commercially available from Allnex.

Some commercially available oligomers which can be used in the transfer coating can include, but are not limited to, multifunctional acrylates that are part of the following families: the PHOTOMER™ Series of aliphatic urethane acrylate oligomers from IGM Resins, Inc., St. Charles, Ill.; the Sartomer SR Series of aliphatic urethane acrylate oligomer from Sartomer Company, Exton, Pa.; the Echo Resins Series of aliphatic urethane acrylate oligomers from Echo Resins and Laboratory, Versailles, Mo.; the BR Series of aliphatic urethane acrylates from Bomar Specialties, Winsted, Conn.; and the EBECRYL™ Series of aliphatic urethane acrylate oligomers from Allnex. For example, the aliphatic urethane acrylates can be KRM8452 (10 functionality, Allnex), EBECRYL™ 1290 (6 functionality, Allnex), EBECRYL™ 1290 N (6 functionality, Allnex), EBECRYL™ 512 (6 functionality, Allnex), EBECRYL™ 8702 (6 functionality, Allnex), EBECRYL™ 8405 (3 functionality, Allnex), EBECRYL™ 8402 (2 functionality, Allnex), EBECRYL™ 284 (3 functionality, Allnex), CN9010™ (Sartomer), CN9013™ (Sartomer), SR351 (Sartomer) or Laromer TMPTA (BASF), SR399 (Sartomer) dipentaerythritol pentaacrylate estersand dipentaerythritol hexaacrylate DPHA (Allnex), CN9010 (Sartomer).

Another component of the transfer resin can be an acrylate monomer having one or more acrylate or methacrylate moieties per monomer molecule. The acrylate monomer can be mono-, di-, tri, tetra- or penta functional. In one embodiment, di-functional monomers are employed for the desired flexibility and adhesion of the coating. The monomer can be straight- or branched-chain alkyl, cyclic, or partially aromatic. The reactive monomer diluent can also comprise a combination of monomers that, on balance, result in a desired adhesion for a coating composition on the substrate, where the coating composition can cure to form a hard, flexible material having the desired properties.

The acrylate monomer can include monomers having a plurality of acrylate or methacrylate moieties. These can be di-, tri-, tetra- or penta-functional, specifically di-functional, in order to increase the crosslink density of the cured coating and therefore can also increase modulus without causing brittleness. Examples of polyfunctional monomers include, but are not limited, to C6-C12 hydrocarbon diol diacrylates or dimethacrylates such as 1,6-hexanediol diacrylate (HDDA) and 1,6-hexanediol dimethacrylate; tripropylene glycol diacrylate or dimethacrylate; neopentyl glycol diacrylate or dimethacrylate; neopentyl glycol propoxylate diacrylate or dimethacrylate; neopentyl glycol ethoxylate diacrylate or dimethacrylate; 2-phenoxylethyl (meth)acrylate; alkoxylated aliphatic (meth)acrylate; polyethylene glycol (meth)acrylate; lauryl (meth)acrylate, isodecyl (meth)acrylate, isobornyl (meth)acrylate, tridecyl (meth)acrylate; and mixtures comprising at least one of the foregoing monomers. For example, the acrylate monomer can be 1,6-hexanediol diacrylate (HDDA), alone or in combination with another monomer, such as tripropyleneglycol diacrylate (TPGDA), trimethylolpropane triacrylate (TMPTA), oligotriacrylate (OTA 480), or octyl/decyl acrylate (ODA).

Another component of the transfer resin can be an optional polymerization initiator such as a photoinitiator. Generally, a photoinitiator can be used if the coating composition is to be ultraviolet cured; if it is to be cured by an electron beam, the coating composition can comprise substantially no photoinitiator.

When the transfer resin is cured by ultraviolet light, the photoinitiator, when used in a small but effective amount to promote radiation cure, can provide reasonable cure speed without causing premature gelation of the coating composition. Further, it can be used without interfering with the optical clarity of the cured coating material. Still further, the photoinitiator can be thermally stable, non-yellowing, and efficient.

Photoinitiators can include, but are not limited to, the following: hydroxycyclohexylphenyl ketone; hydroxymethylphenylpropanone; dimethoxyphenylacetophenone; 2-methyl-1-[4-(methylthio)phenyl]-2-morpholinopropanone-1; 1-(4-isopropylphenyl)-2-hydroxy-2-methylpropan-1-one; 1-(4-dodecylphenyl)-2-hydroxy-2-methylpropan-1-one; 4-(2-hydroxyethoxy) phenyl-(2-hydroxy-2-propyl) ketone; diethoxyacetophenone; 2,2-di-sec-butoxyacetophenone; diethoxy-phenyl acetophenone; bis (2,6-dimethoxybenzoyl)-2,4-, 4-trimethylpentylphosphine oxide; 2,4,6-trimethylbenzoyldiphenylphosphine oxide; 2,4,6-trimethylbenzoylethoxyphenylphosphine oxide; and combinations comprising at least of the foregoing.

Exemplary photoinitiators can include phosphine oxide photoinitiators. Examples of such photoinitiators include the IRGACURE™, LUCIRIN™ and DAROCURE™ series of phosphine oxide photoinitiators available from BASF Corp.; the ADDITOL™ series from Allnex; and the ESACURE™ series of photoinitiators from Lamberti, s.p.a. Other useful photoinitiators include ketone-based photoinitiators, such as hydroxy- and alkoxyalkyl phenyl ketones, and thioalkylphenyl morpholinoalkyl ketones. Also desirable can be benzoin ether photoinitiators. Specific exemplary photoinitiators include bis(2,4,6-trimethylbenzoyl)-phenylphosphine oxide supplied as IRGACURE™ 819 by BASF or 2-hydroxy-2-methyl-1-phenyl-1-propanone supplied as ADDITOL HDMAP™ by Allnex or 1-hydroxy-cyclohexyl-phenyl-ketone supplied as IRGACURE™ 184 by BASF or RUNTECURE™ 1104 by Changzhou Runtecure chemical Co. Ltd, or 2-hydroxy-2-methyl-1-phenyl-1-propanone supplied as DAROCURE™ 1173 by BASF.

The photoinitiator can be chosen such that the curing energy is less than 2.0 Joules per square centimeter (J/cm²), and specifically less than 1.0 J/cm², when the photoinitiator is used in the designated amount.

The polymerization initiator can include peroxy-based initiators that can promote polymerization under thermal activation. Examples of useful peroxy initiators include benzoyl peroxide, dicumyl peroxide, methyl ethyl ketone peroxide, lauryl peroxide, cyclohexanone peroxide, t-butyl hydroperoxide, t-butyl benzene hydroperoxide, t-butyl peroctoate, 2,5-dimethylhexane-2,5-dihydroperoxide, 2,5-dimethyl-2,5-di(t-butylperoxy)-hex-3-yne, di-t-butylperoxide, t-butylcumyl peroxide, alpha,alpha′-bis(t-butylperoxy-m-isopropyl)benzene, 2,5-dimethyl-2,5-di(t-butylperoxy)hexane, dicumylperoxide, di(t-butylperoxy isophthalate, t-butylperoxybenzoate, 2,2-bis(t-butylperoxy)butane, 2,2-bis(t-butylperoxy)octane, 2,5-dimethyl-2,5-di(benzoylperoxy)hexane, di(trimethylsilyl)peroxide, trimethylsilylphenyltriphenylsilyl peroxide, and the like, and combinations comprising at least one of the foregoing polymerization initiators.

The integrated conductive film as disclosed herein can be used in any electronic device having a touch sensing device. For example these integrated conductive films can be used in electronic displays such as televisions, desktop computer displays, public information displays, educational displays, automotive displays, smart windows; mobile electronic devices such as cell phones, portable computers, tablets, wearable electronic devices, such as watches, bands, portions of clothing or other textiles incorporating electronics including touch sensing features; transparent EMI shielding applications, and capacitive sensing applications (such as applications having touch sensing controls).

The integrated conductive film can transmit greater than or equal to 50% (e.g. 50 percent transmittance) of incident electromagnetic radiation having a frequency of 430 THz to 790 THz, for example, 60% to 100%, or, 70% to 100%. A transparent polymer, substrate, film, and/or material of the integrated conductive film can transmit greater than or equal to 50% of incident EMR having a frequency of 430 THz to 790 THz, for example, 75% to 100%, or, 90% to 100%. Percent transmittance for laboratory scale samples can be determined using ASTM D1003, Procedure A, using a Haze-Gard test device. ASTM D1003 (Procedure A, Hazemeter, using Standard Illuminant C or alternatively Illuminant A with unidirectional illumination with diffuse viewing) defines percent transmittance as:

$$\% T = ( \frac{I}{{I}_{o}} ) \times 100 \% \qquad [ 1 ]$$

wherein: I=intensity of the light passing through the test sample
Iₒ=Intensity of incident light.

### Examples

Samples of the integrated conductive film having a width (W) of 66 millimeter (mm), an unbent length (H) of 114 mm, and a thickness (T) of 0.8 mm were tested for change in electrical resistance resulting from flexure between two fixed points using ASTM D5023.

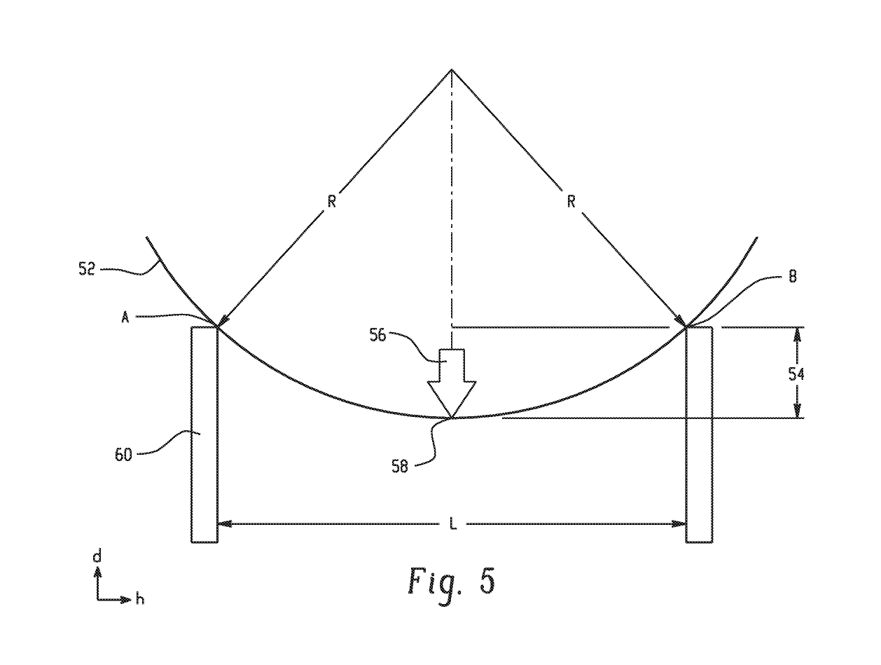

FIG. 5 shows a schematic of the test setup. During the test each sample of the integrated conductive film 52 was placed between two supports 60, separated by a distance, L, and a force 56 was applied to the integrated conductive film 52 at the point 58 centered between the supports 60. The bend radius, R, the range, 54, and the electrical resistance between points A and B were measured as the force 56 was changed. The bend radius, R, corresponds to the radius of a theoretical perfect circle that would pass through the point 58 and the points A and B. The results of the testing are presented in Table 1.

The testing showed that the change in electrical resistance of the samples was less than or equal to 1 ohm as each sample was bent to five different predetermined bend radii. Each sample showed that the electrical resistance of the integrated conductive film can be maintained during a bending event and therefore the functionality as a touch sensing device for an electronic device would be unaffected by such flexure. From these results it is apparent that the integrated conductive film can exhibit a change in electrical resistance of less than or equal to 1 ohm when the film is bent to a bend radius of less than or equal to 136 mm, for example, greater than or equal to a 38 mm, as per ASTM D5023.

TABLE 1
Electrical Resistance of Bent Samples

| | | | | | Bend | |
|---|---|---|---|---|---|---|
| | Force | Designed | Real range | | Radius | Resistance |
| Sample | (Kgf) | range (mm) | (mm) | L (mm) | (mm) | (Ω) |
| 1# | 0.58 | 5 | 4.978 | 70 | 126 | 9 |
| 1# | 1.07 | 10 | 9.954 | 70 | 67 | 10 |
| 1# | 1.34 | 15 | 14.872 | 70 | 49 | 9 |
| 1# | 1.44 | 20 | 19.905 | 70 | 41 | 9 |
| 1# | 1.5 | 25 | 22.948 | 70 | 38 | 9 |
| 2# | 0.58 | 5 | 4.97 | 70 | 126 | 9 |
| 2# | 1.07 | 10 | 9.95 | 70 | 67 | 10 |
| 2# | 1.36 | 15 | 14.942 | 70 | 48 | 10 |
| 2# | 1.46 | 20 | 19.858 | 70 | 41 | 9 |
| 2# | 1.5 | 25 | 22.696 | 70 | 38 | 10 |
| 3# | 0.58 | 5 | 4.962 | 70 | 126 | 8 |
| 3# | 1.08 | 10 | 9.931 | 70 | 67 | 8 |
| 3# | 1.36 | 15 | 14.931 | 70 | 48 | 8 |
| 3# | 1.43 | 20 | 19.843 | 70 | 41 | 9 |
| 3# | 1.54 | 25 | 22.724 | 70 | 38 | 8 |
| 4# | 0.57 | 5 | 4.976 | 70 | 126 | 10 |
| 4# | 1.08 | 10 | 9.954 | 70 | 67 | 11 |
| 4# | 1.36 | 15 | 14.919 | 70 | 49 | 11 |
| 4# | 1.43 | 20 | 19.952 | 70 | 41 | 11 |
| 4# | 1.51 | 25 | 22.606 | 70 | 38 | 11 |

Unless otherwise specified herein, any reference to standards, regulations, testing methods and the like, such as ASTM D1003, ASTM D5023, ASTM D3359 refer to the standard or method that is in force at the time of filing of the present application.

### Embodiment 1

An integrated conductive film comprising: a first substrate including a first surface and a second surface, wherein the first substrate comprises a first polymer; a second substrate coupled to the second surface of the first substrate, wherein the second substrate comprises a second polymer, and wherein the chemical composition of the first polymer is different from the chemical composition of the second polymer; a transfer resin disposed adjacent to the first surface of the first substrate; a conductive coating disposed adjacent to the transfer resin, wherein the coating includes nanometer sized metal particles arranged in a network, and wherein the conductive coating has a surface resistance of less than or equal to 50 ohm/sq; and wherein the integrated conductive film has a transmittance of greater than or equal to 70% of incident light having a frequency of 430 THz to 790 THz, and wherein a change in electrical resistance of the integrated conductive film is less than or equal to 1 ohm when the film is bent to a bend radius of less than or equal to 126 millimeters as per ASTM D5023.

### Embodiment 2

The integrated conductive film of claim 1, wherein the first polymer comprises bisphenol-A polycarbonate, dimethyl bisphenol cyclohexane polycarbonate, and combinations comprising at least one of the foregoing.

### Embodiment 3

The integrated conductive film of any of Embodiments 1-2, wherein the second polymer comprises poly(methyl methacrylate) (PMMA).

### Embodiment 4

The integrated conductive film of any of Embodiments 1-3, wherein the transfer resin comprises a thermoset polymer.

### Embodiment 5

The integrated conductive film of any of Embodiments 1-4, wherein the transfer resin is disposed between the first surface of the first substrate and the conductive coating.

### Embodiment 6

The integrated conductive film of any of Embodiments 1-5, wherein the transfer resin is adhered to the first surface of the first substrate and the conductive coating is at least partially surrounded by the transfer resin.

### Embodiment 7

The integrated conductive film of any of Embodiments 1-6, wherein the integrated conductive film passes a peel test defined by ASTM D3359.

### Embodiment 8

The integrated conductive film of any of Embodiments 1-7, wherein the adhesion between the conductive coating and the first substrate is 5B as determined by ASTM D3359.

### Embodiment 9

The integrated conductive film of any of Embodiments 1-8, wherein a protective portion, capable of providing abrasion resistance to the underlying integrated conductive film, is coupled to a surface of the second substrate.

### Embodiment 10

The integrated conductive film of any of Embodiments 1-9, wherein the thickness of the integrated conductive film is 0.01 mm to 3 mm.

### Embodiment 11

A touch screen comprising: the integrated conductive film of any of Embodiments 1-10.

### Embodiment 12

A method of forming an integrated conductive film comprising: coextruding a substrate having a first surface and a second surface, wherein the first surface comprises a first polymer and the second surface comprises a second polymer, wherein the chemical composition of the first polymer is different from the chemical composition of the second polymer; applying a conductive coating to a transfer sheet, wherein the transfer sheet comprises a third polymer, wherein the coating includes nanometer sized metal particles arranged in a network, and wherein the conductive coating has a surface resistance of less than or equal to 50 ohm/sq; applying a transfer resin to the conductive coating or to the first surface of the substrate, wherein the transfer resin has a low adhesion to the transfer sheet; activating the transfer resin; pressing the transfer sheet and the substrate together, wherein the transfer resin is sandwiched between the conductive coating and the first surface of the substrate; curing the transfer resin; removing the transfer sheet to form the integrated conductive film wherein the integrated conductive film has a transmittance of greater than or equal to 70% of incident light having a frequency of 430 THz to 790 THz, and wherein a change in electrical resistance of the integrated conductive film is less than or equal to 1 ohm when the film is bent to a bend radius of less than or equal to 126 millimeters as per ASTM D5023.

### Embodiment 13

The method of claim 12, wherein the first polymer comprises bisphenol-A polycarbonate, dimethyl bisphenol cyclohexane polycarbonate, and combinations comprising at least one of the foregoing.

### Embodiment 14

The method of any of Embodiments 12-13, wherein the third polymer comprises polyethylene terephthalate (PET).

### Embodiment 15

The method of any of Embodiments 12-14, comprising applying a protective portion to the second surface of the substrate wherein the protective portion is capable of providing abrasion resistance to the underlying integrated conductive film.

### Embodiment 16

The method of any of Embodiments 12-15, wherein activating comprises waiting, heating, drying, exposing to electromagnetic radiation, exposing to air, or a combination of one of the foregoing.

### Embodiment 17

The method of any of Embodiments 12-16, wherein curing comprises waiting, heating, drying, exposing to electromagnetic radiation, exposing to air, or a combination of one of the foregoing.

### Embodiment 18

The method of any of Embodiments 12-17, wherein curing comprises exposing to electromagnetic radiation in the ultraviolet spectrum having a frequency of 750 THz to 30 PHz.

### Embodiment 19

The method of any of Embodiments 12-18, wherein pressing comprises roll to sheet transferring, stamping, roller pressing, belt pressing including double belt pressing, or a combination comprising at least one of the foregoing.

### Embodiment 20

An integrated conductive film made by the method of any of Embodiments 12-19.

### Embodiment 21

An integrated conductive film comprising: a polycarbonate substrate including a first surface and a second surface; a PMMA substrate coupled to the second surface of the polycarbonate substrate; a transfer resin disposed adjacent to the first surface of the polycarbonate substrate; a conductive coating disposed adjacent to the transfer resin, wherein the coating includes nanometer sized metal particles arranged in a network, and wherein the conductive coating has a surface resistance of less than or equal to 50 ohm/sq; and wherein the integrated conductive film has a transmittance of greater than or equal to 70% of incident light having a frequency of 430 THz to 790 THz, and wherein a change in electrical resistance of the integrated conductive film is less than or equal to 1 ohm when the film is bent to a bend radius of less than or equal to 126 millimeters as per ASTM D5023.

In general, the invention may alternately comprise, consist of, or consist essentially of, any appropriate components herein disclosed. The invention may additionally, or alternatively, be formulated so as to be devoid, or substantially free, of any components, materials, ingredients, adjuvants or species used in the prior art compositions or that are otherwise not necessary to the achievement of the function and/or objectives of the present invention.

All ranges disclosed herein are inclusive of the endpoints, and the endpoints are independently combinable with each other (e.g., ranges of “up to 25 wt. %, or, more specifically, 5 wt. % to 20 wt. %”, is inclusive of the endpoints and all intermediate values of the ranges of “5 wt. % to 25 wt. %,” etc.). “Combination” is inclusive of blends, mixtures, alloys, reaction products, and the like. Furthermore, the terms “first,” “second,” and the like, herein do not denote any order, quantity, or importance, but rather are used to denote one element from another. The terms “a” and “an” and “the” herein do not denote a limitation of quantity, and are to be construed to cover both the singular and the plural, unless otherwise indicated herein or clearly contradicted by context. The suffix “(s)” as used herein is intended to include both the singular and the plural of the term that it modifies, thereby including one or more of that term (e.g., the film(s) includes one or more films). Reference throughout the specification to “one embodiment”, “another embodiment”, “an embodiment”, and so forth, means that a particular element (e.g., feature, structure, and/or characteristic) described in connection with the embodiment is included in at least one embodiment described herein, and may or may not be present in other embodiments. In addition, it is to be understood that the described elements may be combined in any suitable manner in the various embodiments.

While particular embodiments have been described, alternatives, modifications, variations, improvements, and substantial equivalents that are or may be presently unforeseen may arise to applicants or others skilled in the art. Accordingly, the appended claims as filed and as they may be amended are intended to embrace all such alternatives, modifications variations, improvements, and substantial equivalents.

I/We claim:

1. An integrated conductive film comprising:
a first substrate including a first surface and a second surface, wherein the first substrate comprises a first polymer;
a second substrate coupled to the second surface of the first substrate, wherein the second substrate comprises a second polymer, and wherein the chemical composition of the first polymer is different from the chemical composition of the second polymer;
a transfer resin disposed adjacent to the first surface of the first substrate;
a conductive coating disposed adjacent to the transfer resin, wherein the conductive coating includes nanometer sized metal particles arranged in a network, and wherein the conductive coating has a surface resistance of less than or equal to 50 ohm/sq; and
wherein the integrated conductive film has a transmittance of greater than or equal to 70% of incident light having a frequency of 430 THz to 790 THz, and wherein a change in electrical resistance of the integrated conductive film is less than or equal to 1 ohm when the integrated conductive film is bent to a bend radius of less than or equal to 126 millimeters as per ASTM D5023.

2. The integrated conductive film of claim 1, wherein the first polymer comprises bisphenol-A polycarbonate, dimethyl bisphenol cyclohexane polycarbonate, and combinations comprising at least one of the foregoing.

3. The integrated conductive film of claim 1, wherein the second polymer comprises poly(methyl methacrylate) (PMMA).

4. The integrated conductive film of claim 1, wherein the transfer resin comprises a thermoset polymer.

5. The integrated conductive film of claim 1, wherein the transfer resin is disposed between the first surface of the first substrate and the conductive coating.

6. The integrated conductive film of claim 1, wherein the transfer resin is adhered to the first surface of the first substrate and the conductive coating is at least partially surrounded by the transfer resin.

7. The integrated conductive film of claim 1, wherein the integrated conductive film passes a peel test defined by ASTM D3359.

8. The integrated conductive film of claim 1, wherein the adhesion between the conductive coating and the first substrate is 5B as determined by ASTM D3359.

9. The integrated conductive film of claim 1, wherein a protective portion, capable of providing abrasion resistance to the underlying integrated conductive film, is coupled to a surface of the second substrate.

10. The integrated conductive film of claim 1, wherein the thickness of the integrated conductive film is 0.01 mm to 3 mm.

11. A touch screen comprising:
the integrated conductive film of claim 1.

12. A method of forming an integrated conductive film comprising:
coextruding a substrate having a first surface and a second surface, wherein the first surface comprises a first polymer and the second surface comprises a second polymer, wherein the chemical composition of the first polymer is different from the chemical composition of the second polymer;
applying a conductive coating to a transfer sheet, wherein the transfer sheet comprises a third polymer, wherein the conductive coating includes nanometer sized metal particles arranged in a network, and wherein the conductive coating has a surface resistance of less than or equal to 50 ohm/sq;
applying a transfer resin to the conductive coating or to the first surface of the substrate, wherein the transfer resin has a low adhesion to the transfer sheet;
activating the transfer resin;
pressing the transfer sheet and the substrate together, wherein the transfer resin is sandwiched between the conductive coating and the first surface of the substrate;
curing the transfer resin;
removing the transfer sheet to form the integrated conductive film
wherein the integrated conductive film has a transmittance of greater than or equal to 70% of incident light having a frequency of 430 THz to 790 THz, and wherein a change in electrical resistance of the integrated conductive film is less than or equal to 1 ohm when the film is bent to a bend radius of less than or equal to 126 millimeters as per ASTM D5023.

13. The method of claim 12, wherein the first polymer comprises bisphenol-A polycarbonate, dimethyl bisphenol cyclohexane polycarbonate, and combinations comprising at least one of the foregoing and wherein the third polymer comprises polyethylene terephthalate (PET).

14. The method of claim 12, comprising applying a protective portion to the second surface of the substrate wherein the protective portion is capable of providing abrasion resistance to the underlying integrated conductive film.

15. The method of claim 12, wherein activating comprises waiting, heating, drying, exposing to electromagnetic radiation, exposing to air, or a combination of one of the foregoing.

16. The method of claim 12, wherein curing comprises waiting, heating, drying, exposing to electromagnetic radiation, exposing to air, or a combination of one of the foregoing.

17. The method of claim 12, wherein curing comprises exposing to electromagnetic radiation in the ultraviolet spectrum having a frequency of 750 THz to 30 PHz.

18. The method of claim 12, wherein pressing comprises roll to sheet transferring, stamping, roller pressing, belt pressing including double belt pressing, or a combination comprising at least one of the foregoing.

19. An integrated conductive film made by the method of claim 12.

20. An integrated conductive film comprising:
a polycarbonate substrate including a first surface and a second surface;
a PMMA substrate coupled to the second surface of the polycarbonate substrate;
a transfer resin disposed adjacent to the first surface of the polycarbonate substrate;
a conductive coating disposed adjacent to the transfer resin, wherein the conductive coating includes nanometer sized metal particles arranged in a network, and wherein the conductive coating has a surface resistance of less than or equal to 50 ohm/sq; and
wherein the integrated conductive film has a transmittance of greater than or equal to 70% of incident light having a frequency of 430 THz to 790 THz, and wherein a change in electrical resistance of the integrated conductive film is less than or equal to 1 ohm when the film is bent to a bend radius of less than or equal to 126 millimeters as per ASTM D5023.
